(19) United States
(12) Patent Application Publication
(10) Pub. No.: US 2011/0116202 A1
(43) Pub. Date: May 19, 2011

(54) REDUCING THE BOUNDARY LAYER OF AERODYNAMIC EFFECTS

(76) Inventors: Francois Giry, Challes les Eaux (FR); Claude Annie Perrichon, L'Isle d'Abeau (FR); Pierre Piccaluga, Macon (FR); Jose Buendia, Bourgoin-Jallieu (FR)

(21) Appl. No.: 12/672,483

(22) PCT Filed: Aug. 8, 2007
(86) PCT No.: PCT/FR07/01353

§ 371 Date: Jan. 11, 2011

(51) Int. Cl. H05F 3/00

(52) U.S. Cl. 361/212

(57) ABSTRACT

Aerodynamic effects are found when air flows over objects such as aircraft and motor cars moving through ambient air. The flow of air through the objects involves issues concerned with aerodynamics. Forced circulation of air through pipes presents numerous problems of aerodynamics because of the variable behavioural modes of operation generally in subsonic mode. Opposing forces then come into play and throttle the flows, thus reducing the effectiveness of a given diameter or cross section under particularly critical conditions in the flow of gases, generally air. The flow of gases or liquids close to the walls is slowed and opposes the overall flow, creating differential flow gradients between the centre of the flow and the peripheral edges thereof. This electronic component known as an eCRT “electron convector real time” which is made up of a very fine mixture of various silica powders to which there are added metal powders, for example titanium powder, aluminium powder, these being added in very precise ratios by those skilled in the art, attracts the electrons and converts them into a vibrational mechanical mode simply through electronic affinity which attracts, transforms and directs the energy of the electrons. The method and devices of this patent can be used to correct and regulate all agitated electrons and free ions, also involved in moving fluids and gases, which devices can be used in the mechanical, aeronautical, space and marine industries and in the field of computers, food stuffs and also the sphere of medicine.

Aerodynamic effects occur when air circulates over objects such as airplanes, automobiles moving through ambient air. The flow of air through the objects also raises aerodynamism issues. The forced flow of air through ducts raises numerous aerodynamic issues because of the modes of operation with variable behaviors generally in subsonic mode. Opposing forces then come into play which throttle the flows, thus reducing the effectiveness of a given diameter or cross section under particularly critical conditions in the flow of gases, generally air. The same applies for liquids, and the terms “aeraulics” and “hydraulics” then apply. Whether it is on gaseous or liquid materials, the flow of the fluids is complicated on the waals of duct pipes. The flow of gases or liquids close to the waals is slowed down and opposes the overall flow creating different flow gradients between the center of the flows and the peripheral edges. This observation is referred to as drag, form, profile on bends for example, friction on pipe surfaces.

The interference drags caused by modifying the pressure or speed of these fluids inside duct pipes greatly modify the overall flow behavior inside the cavities of the ducts, which is the subject of a correction and regularization of the overall flow of the liquid or gaseous fluids by the present patent application. The drag forces that oppose the overall flow movements are corrected by a method deriving from nanotechnology, that modifies the adhesion forces binding the fluids and the gases to the waals of the ducts. The releasing of the electromagnetic adhesion forces, such as the Van der Waals forces and the polar quantum forces created by the agitated flow turbulences of the molecules, give uniform flows on all the sections of the fluid duct or ducts regardless of flow rates and pressures. The fluids themselves are released from the forces of cohesion and tension with the waals that made them less fluid. The electronic forces create surface tensions between the molecules themselves and the waals which slow down the fluidity. These forces contribute to the turbulences within the flow of the gaseous or liquid fluids and, upon contact with the waals, cause boundary layers to be created, reducing the effective overall flow section. The variable flow of the fluids in terms of speed or density varies the overall flows in proportions that cut through any desired operating linearity, making operation unstable, unpredictable and chaotic. This instability makes synchronizing mechanical movements difficult, as well as the chemical balance functions of various components that have to be perfectly dosed for any carburetion systems requiring highly variable energy charges. An example is the intake of air into a carburetion feed which varies strongly in terms of the necessary air flow rate, a flow rate that is then strongly opposed by circulation mode malfunctions within nozzles and suction ducts. The regulation is provided by the present method deriving from understanding in nanotechnology concerning the polarity and the electrovalency charges that the molecules of the fluids polarize and the surface tension forces that are established between the molecules themselves and the waals of the ducts. The material of the ducts obviously interacts well. From rabbit skin rubbed on an ebonite rod to industry, the magnetic charges, the polar forces and the Van der Waals forces to situate the problem are forces that modify the dynamic behavior of the fluids flowing inside and outside solid components. The surface tension ratios are opposed by the electrical charges that are established in numerous forms including those known and stated by Maxwell, Laplace, Van der Waals, Lorentz and Gauss, among others.

The present application directly addresses these issues of intrinsic fluctuation of electronic charge in fluids and gases applied to the forces of the ions and electrons migrating to the molecules in motion. The agitated molecules are subjected to rubbing, friction, shear and slip forces between them and on the surfaces of the waals of the objects that they encounter such as those of automobiles, airplanes, boats, or intake pipes of carburetion devices to give a few nonlimiting examples.

The fluctuations of the ions and electrons are of the same order inside ducts, nozzles, pipes carrying fluids produced in all kinds of materials such as, to give nonlimiting examples, tubes made of polymer plastics or aluminum, copper, metal, to give nonlimiting examples of the products used. The world of nanotechnology allows, through the present method, for a homogenization, a regularity of the fluidity of the overall flows of the fluids and of the gases on the solid surfaces regardless of the overall flow speeds required or profitably undergone, by the affixing of at least one electronic component specific to the present application to the surface of the moving object or to the wall of the duct or ducts or nozzles used to conduct the liquid or gaseous fluids. In the same way as, in electronics, the transistors conduct the movement of the electrons by the polarities and the functions of their electron reservoir insulating components and the conductors that make it possible to circulate the electrons, the present method, through a novel electronic component, allows for an electronic circulation which involves attracting/absorbing the surplus electrons and ions, consuming the electrons that congregate en masse through friction on the fluids and gases and on the waals. The releasing of the polarizations of the surplus ions and electrons on the fluids, the gases and the waals eliminates the interfaces that slow down the flows. These excess electronic imbalances exerted on the fluids and the gases greatly penalize the fluidity factors which are thus corrected by simple electronic cleaning. The cleaning of electronic polarization allows for the ideal optimized used of carburetion. This example greatly reduces CO and CO₂ pollutions and noises, the efficiencies of the engines are perceived through the torque and the power available regularly, spontaneously according to all the required energy regime modes.

The device, the electronic component, affixed to the surfaces of the objects or of the ducts where the fluid or gas movements flow, is greedy for ions and electrons through two essential qualities which are a hunger to attract the electrons and the ions by the inceration of copper or precious metals such as gold having a high valency with a capacity to attract the electrons and the second quality being the hunger of the piezoelectricity which is transient to eat the energy of the ions and electrons, piezo consisting of silicas and quartz of different kinds oscillating at high frequency through quartz crystals like diamond or similar. Nonlimiting example of composition for putting the method in place. The free ions and electrons migrate toward this electronic component which attracts them and consumes them through the piezoelectricity releasing the accumulated electric charges stagnating on the circulating fluids or gases. The electronic component is therefore the amalgam of silica/quartz likely to operate in piezoelectricity mode with the addition of metals or components lacking electrons and ions that naturally attract them.

This electronic component called eCRT, standing for “Electron Convector Real Time”, consisting of a very fine mixture of various silica powders with the addition of metallic powders, such as, for example, titanium, aluminum powder made in very precise ratios by those skilled in the art, can be used to attract the electrons and transform them into a vibratory mechanical mode through the simple electronic affinity which attracts, transforms and directs the energy of the electrons.

The device is molded according to demand and available spaces, and this varies from a few grams to a few hundred grams. Uses on large masses to be cleaned can range up to several kilos.

This molded component can have a number of composition variants that differ by different percentages of silica and of different metals according to the desired specific reactivity. This component or these components is/are placed on the nozzles or the surfaces in motion relative to the fluids or gases concerned. The component can also be placed inside ducts at the center of the flows or on the edges of the flows concerned for the desired corrections. This product is designed to operate with no specific conductor, without an electrical wire that has become pointless, since, in effect, the electronic permeability of air, of space or of the components is sufficient for the electronic ionic exchanges that are possible in these nanometric scale conditions. The ionic electronic affinity differentials do not need conductive wire because the ions or the electrons jump from component to component of empty ionic or electronic space according to the affinity and electronic valency gradients specific to each material, until the energy absorption of the piezoelectricity of the “eCRT” product, which, after having attracted these ions and electrons, consumes the electronic energy in mechanical vibratory form. The device can be coated with a fine layer of plastic, polymer or paper, cardboard, an esthetic packaging or a technical packaging to insulate it from water for example or from chemical attack. In computers, the flows of the ions and electrons in the wires can be likened to fluids in pipes and do not lack similar chaotic functions, which are corrected in the same way. Phase reverses occur that oppose the flow. Corrective frames identify the “multilevel overmodulation” electronic chaos to be eliminated. These spurious phenomena create chaotic functions in electron flows as in the fluids that are well known, and this, in the audio field, affects the sound qualities, which are corrected by this method and devices. The sound alterations due to spurious phenomena are now eradicated and cleaned. In practice, the spurious phenomena are combined in order of magnitude with the harmonics that are no longer distinguished, mixed in the incoherent flows of the multilevel cross phases. The excess ion or electron charges affect in chaotic mode the initial functioning modalities of the fluids and of the electrical information. The same applies in the image processing field. Specific installation for this application is done by simply juxtaposing the device, the novel eCRT electronic component, with the conductive wire or wires or the simple placement of the eCRT in the devices, the permeability acting naturally without electrical wire coupling.

Components and applications of this method can be used to correct and regulate all usages of electrons and agitated ions in motion in electronic physics to eliminate the complex and multilevel phase interferences from the field of computers to the audiovisual field and from the field of fluids and/or gases in motion used in the mechanical, aeronautical and space and marine industries, as well as in field of foodstuffs, and also in the medical field. All these applications have a common reason, the self-induced effects of the polarizations of the charges of the ionic and electronic forces in motion partly described as stated by Laplace, Maxwell, Lorenz, Van der Waals and Gauss among others.

1. A method which is to clean the gases and fluids flowing inside or outside objects of ion or electron charges built up by friction in the circulating flows of the movements, cleaning that is obtained by the presence of a novel electronic component placed on the surface of the objects or in the flows of the liquids or the gases, an electronic component that absorbs the surpluses of the electronic or ionic charges by the electronic affinity of the metals on the one hand and by the voracity of the piezoelectricity of the silicas of the molded electronic component, a component which, by its simple presence, provides for the releasing of the electronic charges making the fluidity uniform to optimize the usages of the fluids or/and of the gases used unaffected by the fluctuations of the electronic charges that create interfaces such as the boundary layers in aerodynamics on the surface of the nozzles or ducts.

2. A device which is an electronic component that is fixed, placed, glued to the surface of an object travelling in space such as an automobile or an airplane, or a fixed, glued to the surface of a duct for a fluid or air in a carburetion system for example, correcting the fluidity in linear mode, or stabilized by releasing the ions and the electrons of the fluids or the gases flowing in the nozzles, pipes and ducts, a device that is characterized by two essential qualities one of which is to attract the ions or the electrons by powdered metals such as aluminum, titanium, to give nonlimiting examples, or components that are eager for electrons or ions, and by the piezoelectricity formed by different silicas with high resonance frequency such as diamond which consumes the energy of the ions and electrons transformed into mechanical vibratory modes, a device that greatly reduces the boundary layer thereby eliminating the chaos, the operating instability, that contributes to the lowering of the CO and CO₂ pollution and by an optimization of engine efficiencies, a lowering of the noises, a device that is molded following the addition of silica powder and powdered metals that are very well mixed in very precise ratios by those skilled in the art.

3. The device as claimed in claim 2, characterized in that the passage of electrons or of the ions occurs naturally through the empty spaces at nanotechnology level, and at the level of the affinities of the electronic valences, a natural permeability, without electrical conductor.

4. The device as claimed in claim 2 is characterized for the use of computers and for audio-visual applications, by putting in place the juxtaposition of the eCRT device, the novel electronic component, with the electronic wires, or its simple placement in the devices, the permeability acting naturally without electrical coupling.

5. The device as claimed in claim 2 can be coated with a fine layer of plastic, polymer or paper, cardboard, an esthetic packaging or a technical packaging to insulate it from water for example or from chemical attack.

6. The method and devices of this patent are used to correct and regulate all the agitated free electrons and ions, also occurring in the moving fluids and gases, devices that are useful in the mechanical, aeronautical, space and marine industries and in the field of computers and foodstuffs and also in the medical field in order to limit the self-induced common effects of the polarizations of the ionic and electronic charges hampering the movements, as stated by Laplace, Maxwell, Van der Waals, Lorenz and Gauss, among others.
